(19) United States
(12) Patent Application Publication
(10) Pub. No.: US 2006/0134399 A1
(43) Pub. Date: Jun. 22, 2006

(54) Method of producing a ceramic article by means of pressure casting

(75) Inventors: Thierry Chartier, Feytiat (FR); Marie-Pierre Comte-Gautron, Senlis (FR); Gilles Gasgnier, Isle (FR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Centre National de la Recherche Scientifique (CNRS, Paris (FR)

(21) Appl. No.: 10/534,845

(22) PCT Filed: Nov. 14, 2003
(86) PCT No.: PCT/FR03/03379

§ 371 Date: Oct. 12, 2005

(30) Foreign Application Priority Data
Nov. 15, 2002 (FR) 02/14305

(51) Int. Cl. B28B 1/26; B32B 3/00; B32B 3/26; B29C 45/00

(52) U.S. Cl. 428/312.2; 264/86; 425/573; 428/312.4; 428/312.6; 428/312.8

(57) ABSTRACT

The invention relates to a method of producing a ceramic article. According to the invention, a slip is pressure cast in a mould (12) in order to form a deposit (20) and a solution (10) containing a deflocculating agent is filtered onto said deposit (20).

The invention relates to the production of ceramic articles.

Pressure die casting (PDC) of a slip (an aqueous suspension of various mineral materials constituting the “formulation” of the ceramic) is a technique widely used in the conventional ceramic sectors, such as tableware and the production of sanitary ware. The technique derives from the conventional casting in a plaster mold, which is the ancestral method used to produce cast parts of complex shape. However, this type of manufacture has a number of drawbacks that pressure die casting partly solves:
slow setting (the formation of cast parts);
delayed demolding (the need to wait until the cast parts in the mold have hardened before demolding);
the molds have to be dried after they have been used a few times;
short lifetime of the molds (fewer than 150 cycles); and
substantial space requirement (stock of molds).

Pressure die casting consists in forming articles from a slip identical to that used in the case of plaster mold casting. This time, the mold is made of a porous resin and the slip is injected under pressure, which may range from 8 to 40×10⁵ Pa approximately. This deposit is produced by filtering out, under pressure, through the mold, most of the water that was used initially to put the various components of the ceramic into suspension. Thus, formation of the cast part is speeded up and, as soon as the cast part has formed, the mold can be opened in order to carry out the demolding operation. As soon as this operation has been completed, the mold can be closed again for a new casting cycle. The mold does not require to be dried, its average lifetime is 20 000 cycles, and it is unnecessary to have more than one or two molds per type of cast part, thereby considerably reducing the space requirement of the workshop.

The pressure die casting cycles depend to a large extent on the rheological characteristics of the slip. These characteristics may be adjusted by means of additives called deflocculants, the action of which may be purely electrostatic or purely steric or electrosteric. The characteristics of the slip must allow a casting cycle as fast as possible to be obtained, while still maintaining good mechanical behavior of the cast part resulting from the casting. This means that the freshly formed cast part must be strong enough to withstand the various handling operations necessitated by the demolding and the finishing steps. These constraints result most of the time in the slips being adjusted in an identical manner for PDC as for conventional casting, whereas PDC would give even better yields if the slips were under-deflocculated. Unfortunately, the use of such slips, although it allows cast parts to be formed more rapidly, results in poor hardening of the ceramic in the mold and in irremediable deformation of the cast parts when they are being demolded.

It should be pointed out at this stage that the structure and the rate of formation of the deposit during pressure die casting are the results of two types of mechanisms depending on the degree of deflocculation of the slip in suspension.

In deflocculated suspensions, the repulsive forces between the mineral particles are high and the particles can move independently of one another. They therefore can be deposited individually and can be rearranged as a more dense (high relative density, low porosity), incompressible and homogeneous deposit. However, because of the high degree of compactness of the deposit, the casting rates are low.

In flocculated suspensions, the attractive forces are high and the particles move and are deposited in agglomerates. The deposit thus formed will be less dense (high porosity), compressible (the particles can be rearranged by applying pressure) and heterogeneous. In contrast, the casting rates will in this case be higher because of a higher porosity.

Moreover, all slips do not behave in the same way during casting. The mineralogical nature of the constituents plays a very important role as regards the rheological characteristics. To simplify matters, slips produced from kaolins (such as for porcelain or vitreous china) “flow well” within the context of conventional casting, which means that they are easy to deflocculate and the setting rates obtained are high. In contrast, clay-based slips (such as for earthenware or stoneware) do not flow well, which means that they are difficult to deflocculate and the setting rates obtained are poor. This is the reason why most of the products produced by pressure die casting in the conventional ceramics sector are porcelains and vitreous china. Earthenware and stoneware producers generally do not use this technology because of the wretched intrinsic Theological characteristics of their suspensions.

The objective of the user is to accelerate the rate of formation of the deposit so as to increase the profitability of the machine. Now, this acceleration is limited by the ability of the deposit formed to remove the residual water and thus allow the article to be gripped when opening the mold. This means that if the slip is “adjusted” in such a way that the rate of formation of the deposit is as rapid as possible, the article will be unable to be demolded without being deformed, as it behaves as a thixotropic solid.

It is an object of the invention to accelerate production by pressure die casting without threatening the mechanical strength of the cast part upon demolding it. Another object of the invention will be to allow conventional ceramic articles to be produced by pressure die casting.

For this purpose, the invention provides a method of producing a ceramic article, characterized in that it comprises the steps consisting in:
casting a slip under pressure into a mold in order to form a deposit; and
filtering a solution containing a deflocculant through the deposit.

Thus, the filtering step makes it possible to compact the deposit of relatively low density that has formed in the preceding step. This post-treatment consists in making a solution containing the deflocculant pass through the deposit. It may be assumed that, during this post-filtration process, the deflocculant molecules will be able to be adsorbed on the surface of the particles and thus will be able to increase the repulsive forces. The particles will then be able to “move” and be rearranged as a more dense deposit with the aid of pressure (higher mechanical integrity of the green casting). The cast part then has suitable mechanical properties for enabling it to be demolded and finished.

The method according to the invention may furthermore have at least one of any of the following features:
the slip is flocculated;
the slip comprises kaolin;
the slip comprises clay;
the slip comprises quartz;
the deflocculant represents at most 3% by weight of the article;
the deflocculant represents at most 5% by weight of the solution; and
the deflocculant represents between 0.20% and 3% by weight of the solution.

The invention also relates to a ceramic article produced by means of the method of the invention.

This article may be a porcelain, vitreous china, earthenware or stoneware article.

The invention also relates to an intermediate product for the purpose of producing a ceramic article, this product being obtained from the mold after the steps of the method of the invention.

The invention also provides a device for producing a ceramic article, comprising a mold, a first tank suitable for containing a slip, a second tank suitable for containing a solution and means for injecting under pressure, into the mold, alternately the slip from the first tank and the solution from the second tank.

Preferably, it includes means for purging the injection means prior to each injection of the slip into the mold.

Other features and advantages of the invention will become apparent over the course of the following description, which presents in particular a preferred embodiment as a nonlimiting example. In the appended drawings:

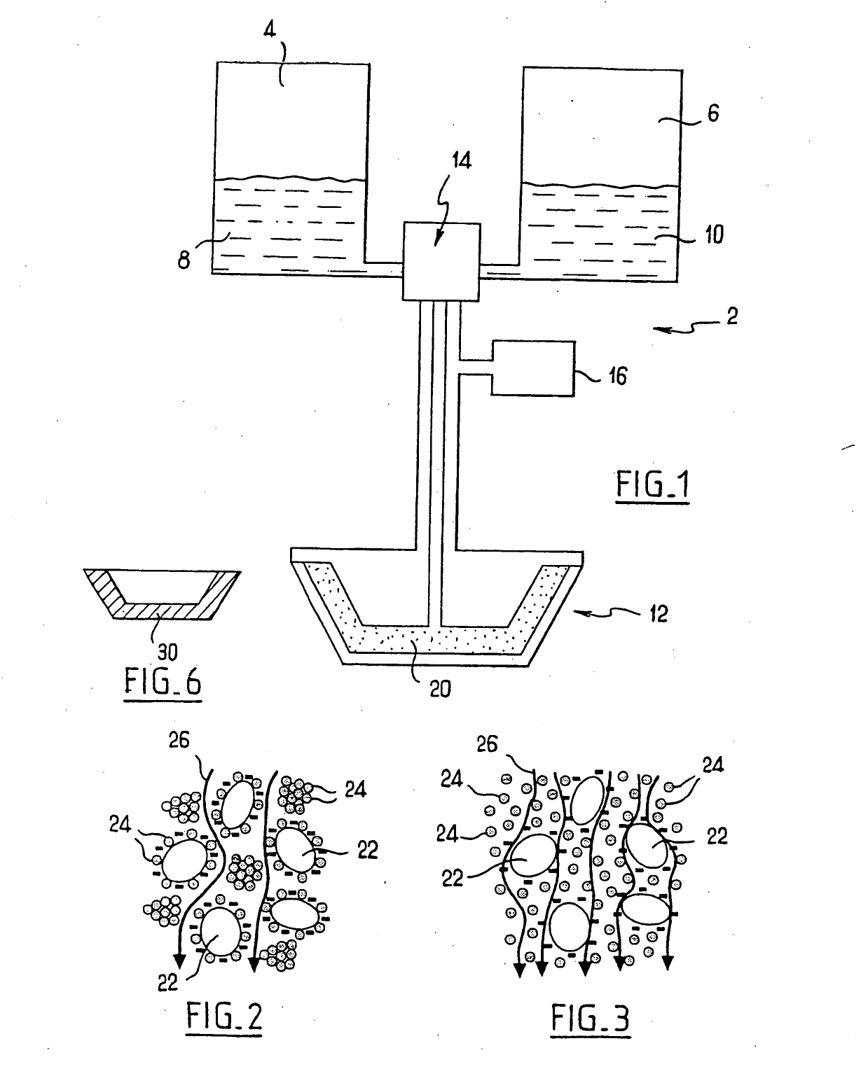

FIG. 1 is a schematic view of one embodiment of the device of the invention;

FIGS. 2 and 3 are two schematic views of the structure of the article on a microscopic scale after the first step and after the second step, respectively, of the method of the invention;

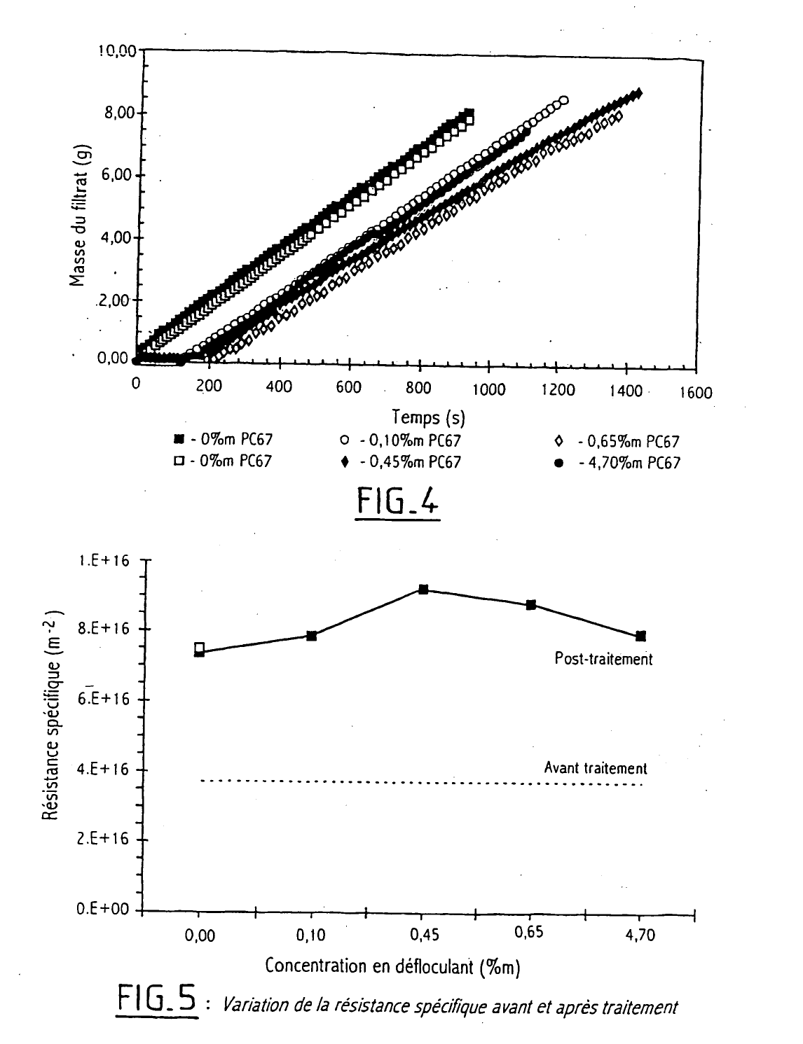

FIG. 4 shows curves illustrating, for various compositions of the filtering solution, the variation in the mass of the filtrate as a function of time;

FIG. 5 is a curve illustrating the specific resistance of the intermediate product as a function of its deflocculant concentration;

FIG. 6 is a sectional view of the article obtained by means of the invention; and

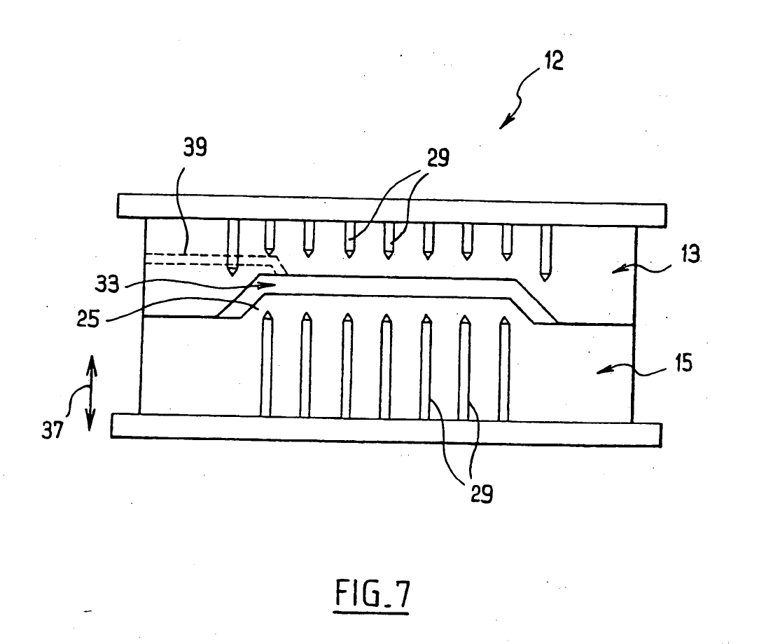

FIG. 7 is a more detailed sectional view of the mold of FIG. 1.

The production device 2 of the present embodiment of the invention is illustrated schematically in FIG. 1.

It comprises two tanks 4 and 6. The tank 4 is suitable for holding a slip 8, while the tank 6 is suitable for holding a filtration solution 10 containing a deflocculant.

The device comprises a pressure die casting mold 12 of conventional type, which may have a horizontal or vertical parting line. It also includes means 14 capable of injecting under pressure, into the mold 12, in turn the slip 8 and the solution 10. These means may be formed by two independent injectors assigned to injecting the slip 8 and the solution 10 respectively, in two separate circuits upstream.

The device comprises means 16 for purging or cleaning the downstream circuit that connects the solution injection means to the mold 12.

Illustrated in greater detail in FIG. 7 is the mold 12 of FIG. 1. The mold 12 comprises two end parts, namely a top part 13 and a bottom part 15. Each of the top and bottom parts has an internal chamber into which a sprue runs, said sprue coming from outside the mold and forming the injection means 14. The top part 13 has a cavity 33 and the bottom part has a head 25 capable of penetrating the cavity 33 when the two mold parts have been joined together as a male-female assembly. In this position, illustrated in FIG. 7, the head 25 occupies only part of the cavity 33 so that the remainder of the cavity 33 forms the molding chamber for forming the part 30 to be molded.

Those portions of the top and bottom parts that are contiguous with the chamber are made of porous materials. Several runners 29 are provided in each of the top and bottom parts. The runners 29 are straight, mutually parallel and separated from one another by identical gaps. They lie along the direction 37, along which the two, top and bottom, parts move relative to one another in order to allow the cast part formed to be extracted from the mold. In both the top and bottom parts, the runners 29 run at right angles towards the cavity 33, without however reaching it, so that they are blind. The runners in the bottom part 15 penetrate into the head 25. In each of the top and bottom parts, the runners 29 connect the main sprue with the core of the porous material. The mold 12 also includes a lateral runner 39 which extends in one or other of the top and bottom parts, for example the top part 13, from the outside of the latter, emerging directly in the chamber 33.

In the present embodiment of the invention, the slip 8 is injected under pressure into the mold 12 in order to form a deposit 20, and then the solution 10 is injected into the mold.

In the first step, the casting is carried out under a pressure of 20×10⁵ Pa. The slip 8 comprises a powder in suspension in an aqueous solution. The powder consists here of 50% kaolin and 50% quartz. It has a median particle diameter such that dₚ ⁵⁰=7 μm and a BET specific surface area such that S_{BET} =6.9 m²/g. The solid phase represents 70% by weight of the slip. The slip has a density of 1.77. The aqueous solution contains, in a very small amount, the deflocculant sold by Zschimmer & Schwartz under the name PC 67, so that the suspension is considered as being under-deflocculated. In this case, the flocculant represents 0.06% by weight of the slip.

The slip is injected, in this case via the lateral runner 39, the water being removed through the porous material and then the runners 29.

By injecting this slip it is possible to obtain a deposit 20 of relatively low density after some of the water has been extracted through the wall of the mold.

In the second step, the injection again takes place under a pressure of 20×10⁵ Pa. The solution 10 is an aqueous solution of deflocculant PC 67 representing between 0.10 and 4.70% by weight of the solution (for example up to 1% by weight of the final article 30). The solution 10 is injected here via the lateral runner 39. During this second step, the solution flows through the deposit 20 and the water escapes through the wall of the mold and then the vertical runners 29.

After a suitable period, the mold is opened and water and compressed air are injected in order to separate the casting produced from the two parts of the mold. This injection takes place via the runners 29. The intermediate product 20 is removed from the mold for the purpose of finishing it in a manner known per se (firing, etc). in order to obtain the article 30 shown in FIG. 6.

Various concentrations by weight (mass of deflocculant/total mass of the solution 10) between 0 and 4.70% (i.e. 0 to 1% relative to the mass of solid) were tested. For each test, the filtration rate was characterized (by measuring the mass of filtrate collected over the course of time, by calculating specific resistance, that is to say the resistance to the flow of water), and the structure of the deposit obtained (porosity, pore diameter, mechanical strength).

FIG. 4 shows the rate of filtration of the deflocculant solutions 10, the deflocculant concentration varying from 0 to 4.70%, through the deposit 20. Two types of behavior may be observed.

In the absence of deflocculant, the filtrate passes very rapidly through the deposit. There is no dead time before the onset of filtrate outflow.

In the present of a deflocculant, the filtrate outflow through the entire deposit is effective only after 114, 169, 222 and 128 s for deflocculant concentrations by weight of 0.10, 0.45, 0.65 and 4.70% respectively. This dead time therefore increases with the deflocculant concentration, except for the highest concentration.

The variation in the filtrate outflow rate was also studied over the course of the filtration of the deflocculant solutions, the deflocculant concentration of which varies from 0 to 4.70%, through the deposit. For times longer than the dead time, the filtrate outflow rate is independent of time, but varies slightly with the deflocculant concentration.

FIG. 5 shows the specific resistance of the deposits before and after treatment. It is clearly apparent that the resistance of the deposits after treatment (the curve shown by the solid line) is twice as high as that obtained by simple casting (the curve shown by the dotted line). This result demonstrates that the porous structure of the deposit has been modified (the particles are rearranged into a more dense structure).

Mechanical bending strength tests were also carried out on the deposits after treatment and drying. The results are given in the table below. The deflocculant concentration as a percentage by weight in the solution is indicated by C_{D} and the three-point bending strength, in MPa, is indicated by σ.

| | Specimen | | |
|---|---|---|---|
| | 1 | 2 | 3 |
| C_{D} (% m) | 0 | 0.65 | 4.70 |
| σ (MPa) | 0.6 | 0.7 | 1.3 |

It was apparent that the deposit obtained after filtration of a solution containing 4.70% of deflocculant has a mechanical strength twice as high as that obtained for the other deposits. This significant change in mechanical strength shows that the structure of the deposit has been modified.

The post-filtration tests demonstrate the following points:

The outflow of the solution 10 containing the deflocculant is effective only after 100 to 200 s, unlike water for which the outflow takes place without any dead time. This result shows that, in the presence of a deflocculant, the flow of the solution causes modifications to the porous structure before it can flow out through the entire thickness of the deposit. With water alone, the outflow through the thickness of the deposit does not modify the structure since its outflow takes place without any dead time.

After treatment, the specific resistance of the deposit is increased, as is its mechanical strength. This increase shows that the outflow of a deflocculant solution through a deposit of low density allows the particles to be rearranged into a more compact (mechanically stronger and more homogeneous) structure.

This post-filtration method therefore makes it possible to obtain a denser deposit thanks to the rearrangement of the particles during this process.

The deposit compaction mechanism may be the following. FIG. 2 illustrates the deposit 20 after the flocculated suspension 8 has been cast; The coarse quartz particles 22, the point of zero charge of which lies at around a pH of 2, are negatively charged in the suspension, where the pH is around 7-8. These particles will therefore be repelled by electrostatic repulsion. However, the small kaolin particles 24 have a point of zero charge at around 8-9. These uncharged particles in the suspension will agglomerate amongst themselves and around the quartz particles 22 owing to the attractive van der Wall's and electrostatic forces respectively. The deposit obtained after casting this suspension will therefore be formed from blocks of quartz particles surrounded by kaolin, with a high porosity allowing rapid outflow of the liquid phase.

FIG. 3 illustrates the deposit after injection of the solution 10. The deflocculant contained in the solution will be able to be absorbed on the kaolin particles 24 and negatively charge them. The deflocculant is negatively charged (COO⁻ group in the case of a polyacrylate). These particles will then be able to be repelled, by the repulsive (electrosteric) forces and therefore will be individually rearranged into a denser deposit (with a lower porosity and a higher mechanical strength).

In these two figures, the arrows 26 represent the outflow of the filtrate.

The pressure die casting of a slip, preferably a flocculated slip, followed by a post-treatment for the purpose of reorganizing the particle deposit so as to make it capable of undergoing the rest of the production process opens up certain prospects as regards PDC.

This is because it improves the manufacturing yield of products produced with slips “that cast well” (porcelain, vitreous china). It is thus possible to substantially reduce the duration of the casting cycle by injecting a flocculated slip and then carrying out the in situ deflocculation by a post-treatment.

A second application of the invention consists in applying the principle to slips “that do not cast well” such as those for earthenware and stoneware, or any other slip containing a high proportion of clay. The method described here makes it possible in fact to use such PDC slips, whereas this was not the case previously in the design of the method and the machines.

The application of the invention to existing pressure die casting machines is relatively simple:

The pumping and pressurized delivery system 14 will have to be preferably capable of conveying suspensions having a higher viscosity than the viscosities usually employed in the prior art.

The purging of the system for conveying the deflocculant solution will have to be complete before any new injection of slip so as not to produce unintentional deflocculation of said slip. Thus, after injection of the solution 10 as post-treatment, the purging means 16 is activated in order to clean that portion of the circuit that has to be followed by the solution 8 during the next cycle.

Of course, many modifications may be made to the invention without departing from the scope thereof.

The invention is applicable to any type of ceramic. Thus, it will be applicable to the conventional clay-based ceramics used for tableware or sanitary ware. It will also be applicable to high-performance ceramics (such as those based on silicon nitride or silicon carbide), for example for manufacturing substrates for electronic components or refractory materials.

1. A method of producing a ceramic article (30), characterized in that it comprises the steps consisting in:
casting a slip (8) under pressure into a mold (12) in order to form a deposit (20); and
filtering a solution (10) containing a deflocculant through the deposit (20).

2. The method as claimed in claim 1, characterized in that the slip (10) is flocculated.

3. The method as claimed in either of claims 1 and 2, characterized in that the slip (10) comprises kaolin.

4. The method as claimed in any one of claims 1 to 3, characterized in that the slip comprises clay.

5. The method as claimed in any one of claims 1 to 4, characterized in that the slip (10) comprises quartz.

6. The method as claimed in any one of claims 1 to 5, characterized in that the deflocculant represents at most 3% by weight of the article (30).

7. The method as claimed in any one of claims 1 to 6, characterized in that the deflocculant represents at most 5% by weight of the solution (10).

8. The method as claimed in any one of claims 1 to 7, characterized in that the deflocculant represents between 0.20% and 3% by weight of the solution (10).

9. A ceramic article (30), characterized in that it is produced by means of the process as claimed in one of claims 1 to 8.

10. The article (30) as claimed in claim 9, characterized in that it is formed in a ceramic chosen from the following group: porcelain, vitreous china, earthenware and stoneware.

11. An intermediate product (20) for the purpose of producing a ceramic article (30), characterized in that the product is obtained from the mold after the steps set out in claim 1.

12. A device for producing a ceramic article (30), comprising a mold (12) and a first tank (4) suitable for containing a slip (8), characterized in that it comprises a second tank (6) suitable for containing a solution (10) and means (14) for injecting under pressure, into the mold (12), alternately the slip from the first tank and the solution from the second tank.

13. The device as claimed in claim 12, characterized in that it includes means (16) for purging the injection means (14) prior to each injection of the slip into the mold.
